(19) United States
(12) Patent Application Publication
(10) Pub. No.: US 2013/0071708 A1
(43) Pub. Date: Mar. 21, 2013

(54) Battery

(71) Applicant: Darwin Danton Delans, North Wales, PA (US)

(72) Inventor: Darwin Danton Delans, North Wales, PA (US)

(73) Assignee: OnePoint Solutions, L.L.C.

(21) Appl. No.: 12/926,013

(22) Filed: Oct. 21, 2010

Related U.S. Application Data
(60) Provisional application No. 61/279,350, filed on Oct. 21, 2009.

(51) Int. Cl. H01M 2/12; H01M 2/30; H01M 2/08

(52) U.S. Cl. 429/82; 429/185; 429/179

(57) ABSTRACT

A battery is provided with a container, one cell wide, having a top, a bottom, two end walls, a closed side wall and an open side. Plural plate elements are formed by connecting together a plurality of positive plates, each with a tab on one side, and a plurality of negative plates, each with a tab on an opposite side. The plural plate elements are inserted face first and positioned through the open side into the container. A separate cover seals the open side of the container and compresses the plural plate elements in the container. The battery may be either a sealed, valve-regulated, lead acid type or a lithium ion type. The container may have one or more cells and head space which serves as an electrolyte reservoir. The container also has holes formed in the two end walls. A pre-cast post is arranged either in each of the holes on one side of a multi-cellular container or in a single hole in each opposite end wall of a single-cell container. A transitional strap connects adjacent holes formed in the end walls of the multi-cellular container on a side opposite from the pre-cast posts. The separate cover has at least one hole formed therein. A vent plug is installed in the hole formed in the separate cover. The pre-cast post includes a central copper insert surrounded by a lead terminal which is partially surrounded by a plastic collar.

### CROSS-REFERENCE TO RELATED APPLICATION

This application claims priority from U.S. Provisional Patent Application Ser. No. 61/279,350 filed on Oct. 21, 2009.

### STATEMENT REGARDING FEDERALLY SPONSORED RESEARCH & DEVELOPMENT

The subject of this application was not funded by any federally sponsored research and development.

### JOINT RESEARCH AGREEMENT(S)

This application is not the result of any joint research agreement.

### BACKGROUND OF THE INVENTION

Conventional battery containers have their covers on the top so that plate elements, i.e. a series of interleaved positive and negative plates connected together, may be inserted edge first through the top. A tab is arranged on the top edge of each plate.

U.S. Pat. No. 4,983,475 was issued on Jan. 8, 1991, to Delans and is an earlier development by the present inventor in the field of batteries.

U.S. Pat. No. 5,512,388 was issued on Apr. 30, 1996, to Pulley et al. and provides a teaching of cell assembly having an open side for inserting active elements. See the language in the abstract and the description of this feature at col. 2, starting at line 49. See also the description at col. 3, starting at line 38.

U.S. Pat. No. 2,640,865 was issued on Jun. 2, 1953, to Brennan and gives an early teaching about the need to pressurize stacked plate cells to improve battery performance. See col. 1 at line 35. An integral side element 5 applies pressure. See col. 3 at lines 10-16. An external terminal 3 and a vent 4 are located in a fixed top wall of the cell. See col. 3 starting at line 27.

U.S. Pat. No. 2,590,804 was issued on Mar. 25, 1952, to Vitale and shows a slidable side cover 18, not separate from a container, in a battery, shown best in FIG. 1.

U.S. Pat. No. 4,964,878 was issued on Oct. 23, 1990, to Morris and teaches compressing cell plates at col. 7, starting at line 37.

U.S. Pat. No. 4,336,314 was issued on Jun. 22, 1982, to Yonezu et al. and also teaches compressing cell plates at col. 8, starting at line 5.

U.S. Pat. No. 1,664,126 was issued on Mar. 27, 1928, to Meisekothen and teaches an integral side cover for a battery container at E of FIG. 4 and on page 1, starting at line 95.

U.S. Pat. No. 6,551,741 was issued on Apr. 22, 2003, to Hamada et al. and shows a small chemical battery best seen in the top view of FIG. 1B.

U.S. Pat. No. 1,737,445 was issued on Nov. 26, 1929, to Anthony and discusses a small battery at page 1, starting at line 55.

### SUMMARY OF THE INVENTION

The present invention relates to a battery with a container which has its cover on the side instead of the top. This arrangement allows plate elements to be inserted face first through the side instead of edge first through the top. This configuration also has its terminal posts mounted onto the container before the plate elements are inserted.

One feature of the invention is that the tabs are arranged on opposite sides of alternating plates instead of on the top edge.

Another feature of this invention is that the head space within the container will be filled with a liquid-absorbing material which will act as an electrolyte reservoir for sealed valve-regulated lead acid (VRLA) batteries with an Absorbed Glass Mat (AGM) or other chemical couples. For VRLA AGM batteries, the electrolyte is acid.

An additional feature of the present invention is that a separate cover, when sealed to the container, acts as a compressor to ensure the plate elements are touching each other, thus providing maximum performance and life. This is particularly true for sealed VRLA AGM batteries.

Thus, the present invention relates to a battery with a specially configured container wherein either single or multiple plate elements are housed and compressed. The container is arranged such that insertion of each plate element is made face first through an open front side which is subsequently sealed by a separate cover affixed thereto.

A container with only a single plate element may have its two external terminal posts heat sealed at opposite ends of the container. Each plate element is attached to the positive and negative posts by spot welding or other conventional means. After assembly, the separate cover is sealed to the open side of the container, thus simultaneously compressing the single plate element to a predetermined compressive pressure. The container depth has been sized so that the desired amount of compression is applied to the plate elements when the separate cover is attached to the open side, thus increasing their effectiveness. The separate cover may include suitably located vent and filler holes. A plurality of cells may be combined into a multi-cell embodiment. Standard manufacturing techniques are used to connect individual cells together or to connect end cells with external terminal posts and a transitional strap. The cells of a multi-celled version are arranged vertically, i.e. plate elements are edge to edge instead of face to face, so that the battery footprint is minimized. Thus, the resulting battery is tall and thin.

### BRIEF DESCRIPTION OF THE DRAWINGS

FIG. 1 is a broken-away, top perspective view of a prior art battery container.

FIG. 1A is a perspective view of plural prior art plate elements, each with a positive tab on a top edge of a positive plate and a negative tab on a top edge of a negative plate.

FIG. 2 is an exploded, side perspective view of a first embodiment of a single-cell battery container of the present invention.

FIG. 2A is a perspective view of plural plate elements of the present invention with a positive tab on a left vertical side of a positive plate and a negative tab on a right vertical side of a negative plate.

FIG. 3 is an exploded, side perspective view of a first embodiment of a multi-cell battery container of the present invention.

FIG. 4 is a cross-sectional side view of a pre-cast post for the first embodiment of the present invention.

FIG. 5 is a cut-away, top, perspective, cross-sectional view of a conventional post, top cover and container used in a prior art battery.

FIG. 6 is a broken-away, cross-sectional side view of the pre-cast post attached to the first embodiment of the multi-cell container of FIG. 3 of the present invention.

FIG. 7A is a top plan view of a plastic transitional strap with an encapsulated metallic electrical conductor in the first embodiment of the battery container of the present invention. The metallic electrical conductor inside the transitional strap is shown in dashed lines.

FIG. 7B is a broken-away, cross-sectional side view of the transitional strap attached to the first embodiment of the multi-cell container of FIG. 3 of the present invention.

FIG. 7C is a broken-away, cross-sectional end view of the transitional strap at the left side and the pre-cast post at the right side of the first embodiment of the multi-cell container of FIG. 3 of the present invention.

FIG. 8 is an exploded, side perspective view of the first embodiment of the single-cell container of FIG. 2 with the plural plate elements of FIG. 2A and the posts of FIG. 4 installed.

FIG. 9A is an exploded, side perspective view of the first embodiment of the multi-cell container of FIG. 3 with the transitional strap of FIG. 7A installed on the right side and the pre-cast posts of FIG. 4 installed on the left side of the container. The transitional strap hidden on the right outer side of the container is shown in dashed lines.

FIG. 9B is an exploded, side perspective view of a wider multi-cell container of the present invention with the posts and the transitional strap installed.

FIG. 10A is a cross-sectional, top plan view of a second embodiment of a single-cell container of the present invention.

FIG. 10B is a cross-sectional, side view of the second embodiment of the single-cell container of FIG. 10A of the present invention.

FIG. 100 is a cross-sectional, top plan view of four single cells connected together with a transitional bus bar at the far right side.

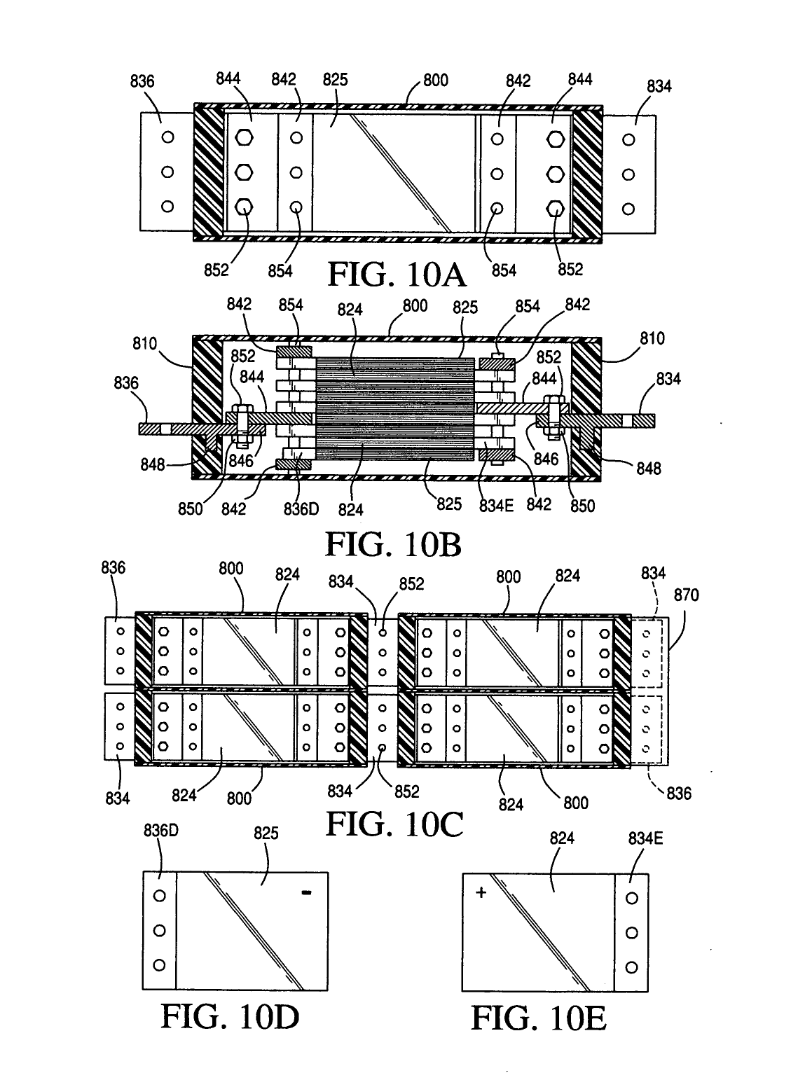

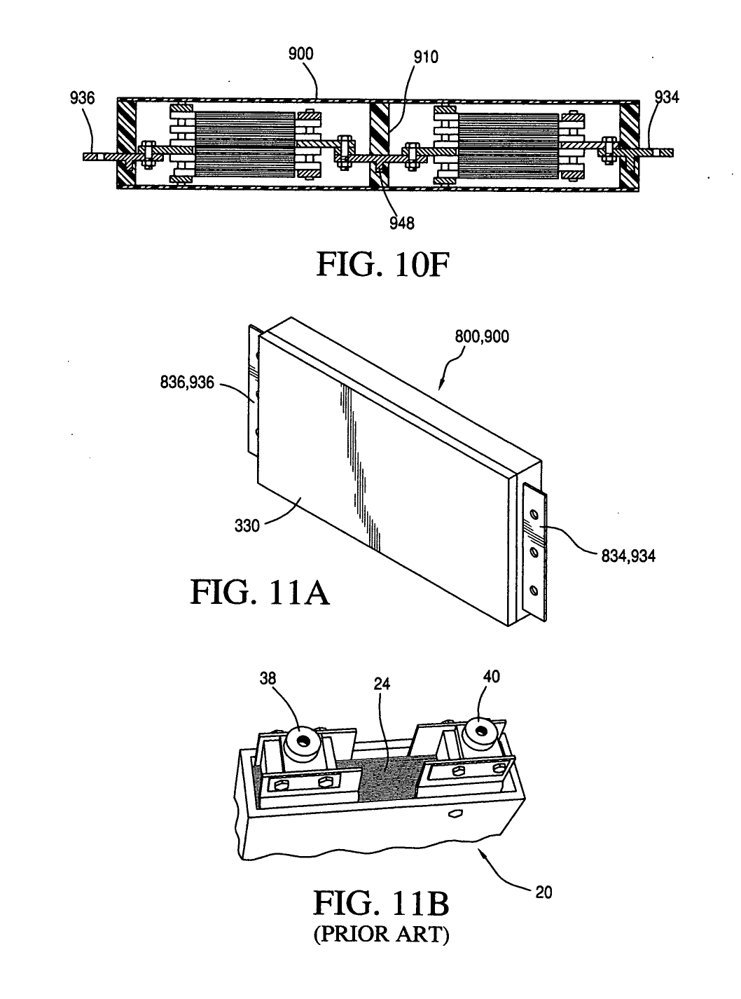

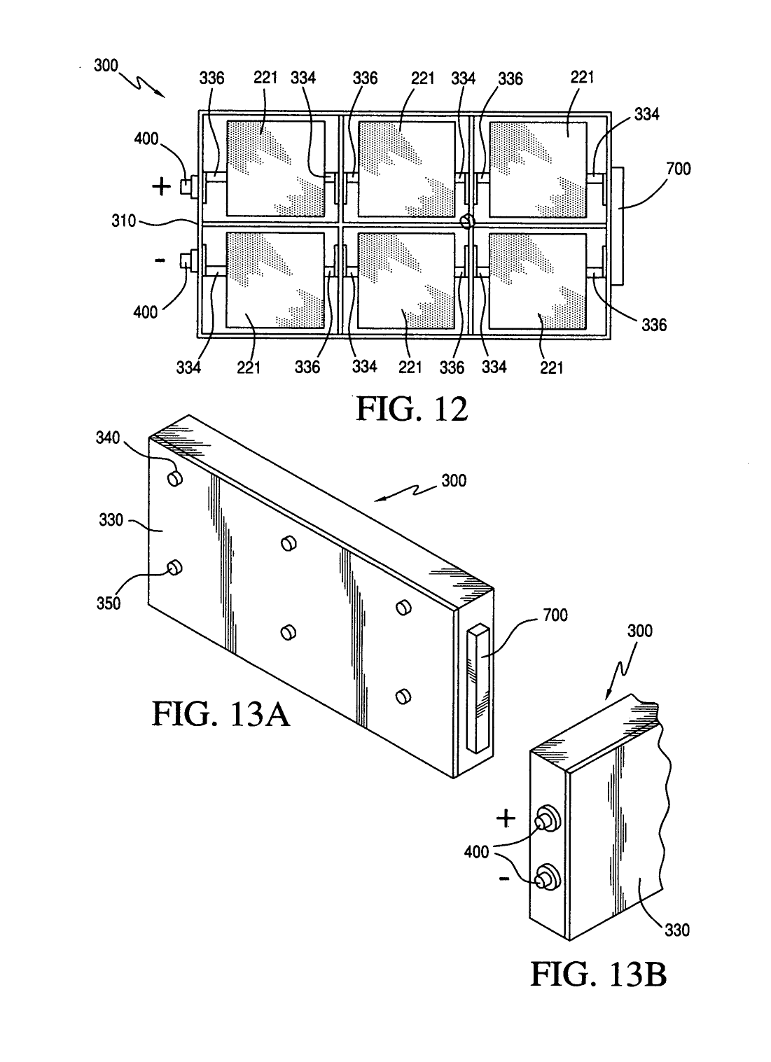

FIG. 10D is a top plan view of a negative plate, with a full-width tab at its left side, for insertion into the second embodiment of the container of the present invention.

FIG. 10E is a top plan view of a positive plate, with a full-width tab at its right side, for insertion into the second embodiment of the container of the present invention.

FIG. 10F is a cross-sectional side view of a second embodiment of the multi-cell container of the present invention.

FIG. 11A is a closed, side perspective view of the second embodiment of either the single-cell container of FIG. 10A or the multi-cell container of FIG. 10F of the present invention.

FIG. 11B is a broken-away, top perspective view of plural plate elements with two posts in a prior art battery.

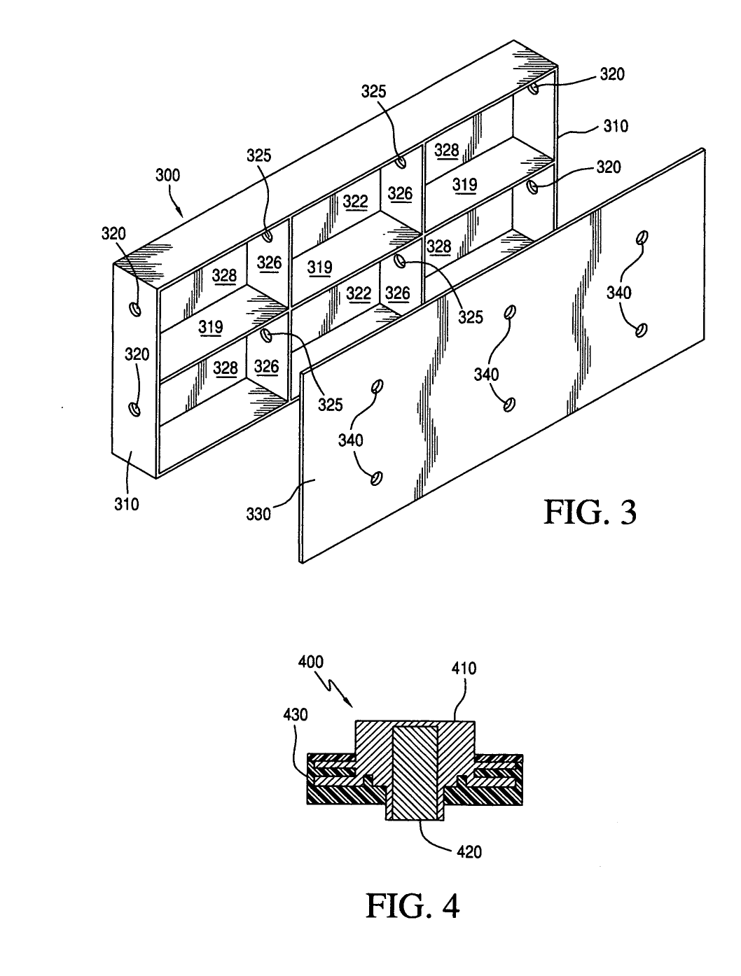

FIG. 12 is an open side view of the first embodiment of the multi-cell container of FIGS. 3 and 9A with a plurality of plate elements installed, the transitional strap of FIG. 7A at the right side and two pre-cast posts of FIG. 4 at the left side.

FIG. 13A is a closed, side perspective view of the first embodiment of the multi-cell container of FIG. 9A with the transitional strap of FIG. 7A on the right outer side.

FIG. 13B is a broken-away, closed, left end perspective view of the first embodiment of the multi-cell container of FIG. 13A with the pre-cast posts of FIG. 4 installed.

### DETAILED DESCRIPTION OF PREFERRED EMBODIMENTS

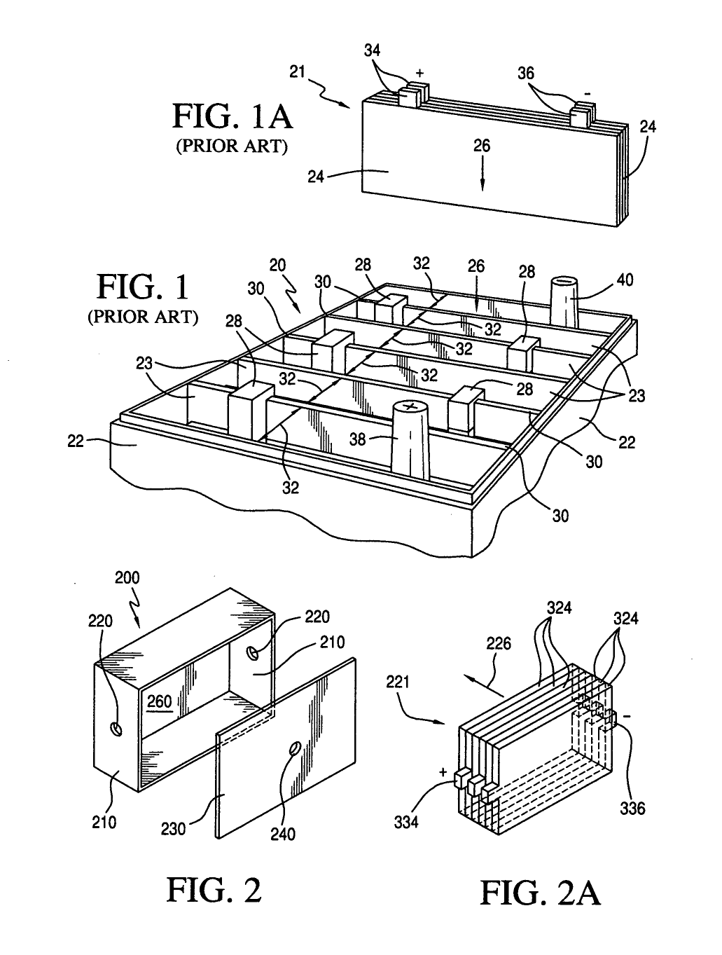

As shown in FIG. 1, most prior art single and multi-cellular, sealed, valve-regulated, lead acid (VRLA) batteries use a container 20 that has four vertical sides 22, only two of which are shown, a top cover (not shown), and a bottom (also not shown). The typical multi-cellular container 20 has a plurality of plate elements 21 shown in FIG. 1A. The plural plate elements 21 have multiple positive plates 24, each with a tab 34, and multiple negative plates 24, each also with a tab 36. A thin glass mat (not shown) is placed between adjacent plate elements 21. The plural plate elements 21 are then compressed and installed in FIG. 1. The top of the container 20 is open to allow vertical insertion of the plural plate elements 21 of FIG. 1A straight down in the direction of the arrow 26. Each plate element 21 is assembled and put under compression outside the container 20. Plural plate elements 21 are then inserted bottom edge first through the open top of the container 20 into a cell 32. Inter-cell connections 28 bridge adjacent pluralities of plate elements 21 by overhanging a top edge 30 of a cell-dividing wall 23. Each individual plate 24 has either one positive tab 34 or one negative tab 36, as seen in FIG. 1A. Each inter-cell connection 28 connects one plurality of plate elements 21 in one cell 32 with a plurality of plate elements 21 in the adjacent cell 32. An external positive post 38 is connected to its adjacent plurality of plate elements 21 (not shown) and an external negative post 40 is connected to its adjacent plurality of plate elements 21 (also not shown). The cover (not shown) is then heat sealed to the container 20. A gas feed torch is used to seal each lead terminal post 38 and 40 to a lead insert (not shown) on an underside of the cover (also not shown), thus leaving only terminal ends of the posts 38 and 40 exposed to the atmosphere. Then each cell 32 is filled with electrolyte through filler holes (not shown) in the top cover (also not shown).

FIG. 2 shows a first embodiment of a container 200 for a single-cell battery of the present invention. The container 200 has end walls 210 in which holes 220 are punched for terminal ends of posts (not shown) to protrude through. A separate cover 230 has a filler vent hole 240 punched through its center. The holes 220 and 240 may be formed by other methods, e.g. drilling. The cover 230 is aligned parallel to a back wall 260.

FIG. 2A shows plural plate elements 221 having multiple positive plates 324, each with a tab 334 at the left side. Multiple negative plates 324, each with a tab 336 at the right side, are inter-leafed with the multiple positive plates 324. The plural plate elements 221 are inserted in the direction of an arrow 226 into the container 200 of FIG. 2 and compressively sealed inside by the cover 230.

FIG. 3 shows a first embodiment of a multi-cell container 300 for the present invention. In this example, there are six cells, but any number may be used, depending upon the electric power demands of the device to which the battery is connected. The container 300 has end walls 310 in which holes 320 are punched or formed in other ways for terminal ends of posts (not shown) to protrude through one end wall 310 and also for transitional straps (not shown) to be attached to the opposite end wall 310. Internal middle cells 322 have holes 325 for plate elements (not shown) to be connected with other plate elements (not shown) in adjacent end cells 328. A wall 319 separates adjacent end cells 328 and adjacent middle cells 322 horizontally while walls 326 separate vertically adjacent opposite end cells 328 from the middle cells 322. A separate cover 330 is used to seal the open side of the container 300 and has plural filler vent holes 340 punched through or formed in other conventional ways for access to each of the middle cells 322 and the end cells 328.

As shown in FIGS. 2 and 3, each single cell and multi-cell container of the present invention has holes 220 and 320, respectively, for at least two external pre-cast posts 400, as shown in FIG. 4. Each post 400 is either heat sealed or glued to the end walls 210 of the container 200 or one end wall 310 of the container 300, shown respectively in FIGS. 2 and 3.

The pre-cast post 400 of FIG. 4 is composed of a lead terminal 410, a copper insert 420 through the center of the lead terminal 410, and a plastic collar 430 which partially surrounds the lead terminal 410.

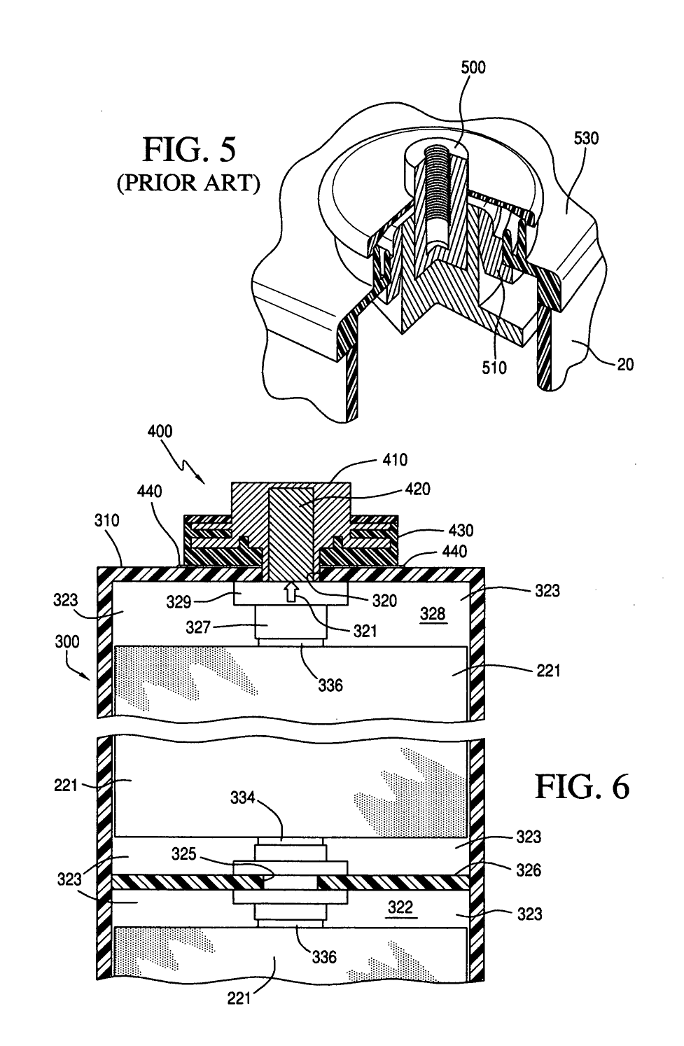

FIG. 5 shows a prior art lead post 500 protruding through a plastic cover 530 which has been heat sealed to a top edge of the container 20 of FIG. 1. After the cover 530 is placed over the lead post 500 and heat sealed to the container 20, a gas-fired torch is used either to melt a lead stick (not shown) or to melt part of the lead post 500 to a lead insert 510 of the cover 530 in order to fuse the post 500 to the insert 510.

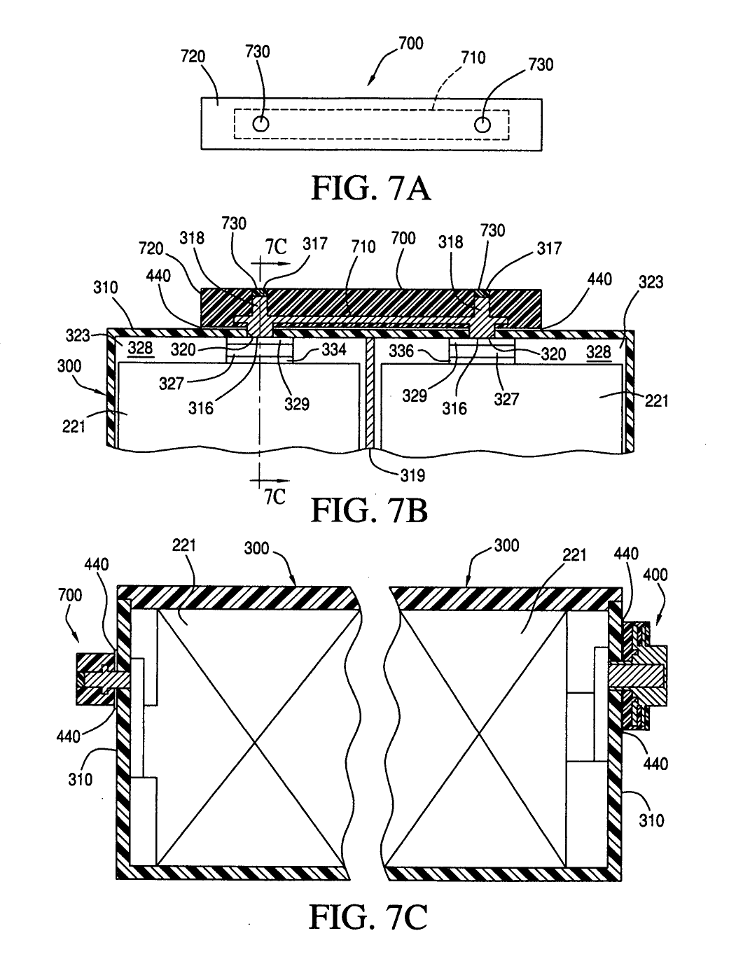

FIG. 6 shows internal details of the multi-cell container 300 of FIG. 3. Inside the container 300, there are two plate elements 221 in two separate cells 328 and 322 divided by the wall 326 having the hole 325 punched through or formed in other ways for inter-connection of the plate elements 221. Multiple positive plates (not shown), each with a tab 334 at one side, and multiple interleaved negative plates (also not shown), each with a tab 336 at an opposite side, constitute plural plate elements 221. The pre-cast post of FIG. 4 is heat sealed or glued in an area 440 of the end wall 310 of the container 300 in FIG. 6 over the hole 320. The copper insert 420 of the pre-cast post 400 is then spot welded in a mating area, indicated by an arrow 321, of a riser 329 which is affixed to a strap 327. The fusion by spot welding provides an electrical circuit between the inside and the outside of the container 300. Minimal heat is required to fuse the copper insert 420 to the riser 329. A key benefit is that a spot welder uses considerably less sustained heat then presently used gas-fired torches which require sustained heat to fuse the components together. Less heat minimizes the chance of distorting the plastic collar 430 partially surrounding the lead terminal 410 of the post 400. This benefit reduces the possibility of a fluid leak around the mating area 440 between the collar 430 and the end wall 310. Head space 323 in the cells 328 and 322 is filled with an electrolyte-absorbing material and serves as a reservoir which will add life to sealed batteries using VRLA and AGM technology. This reservoir feeds acid to a glass mat (not shown) packed between adjacent plate elements 221 inside the container 300.

FIG. 7A shows a top view of a transitional strap 700 which includes a metallic electric conductor 710, shown in phantom lines, and a plastic casing 720. Plastic plugs 730 provide access for spot welding the metallic electric conductor 710 inside the plastic casing 720 to the plate element (not shown) underneath.

FIG. 7B shows a side view of the transitional strap 700 heat sealed or glued in the area 440 at the right side of the multi-cell container 300 of FIG. 3. Inside the container 300 of FIG. 7B, there are two plate elements 221 in two separate but adjacent end cells 328 divided by the wall 319. Multiple positive plates (not shown), each with the tab 334 at one end, and multiple negative plates (also not shown), each with the tab 336 protruding from the opposite end, constitute plural plate elements 221. Each cell 328 has its own hole 320 through the end wall 310. The hole 320 allows a bottom end 316 of a protuberance 318 of the conductor 710 to be spot-welded to the riser 329. One of the spot welder tips would be placed on the metallic electric conductor 710 under the plugs 730 and another spot welder tip under the riser 329. The plate strap 327 connects the riser 329 to the plate element 221 in each cell 328. Heat sealing the mating area 440 and generating minimal heat by the spot welder preserves the integrity of the bond between the metallic conductor 710 and its plastic casing 720 and also minimizes the chance of electrolyte leaking through the holes 320. For sealed batteries using VRLA and AGM technology, the head space 323 in the two adjacent cells 328 is filled with electrolyte-absorbing material to serve as a reservoir to feed acid to the glass mats (not shown) packed between adjacent plate elements 221 inside the container 300.

FIG. 7C is a cross-sectional end view of the transitional strap 700 of FIG. 7A at the left side and the pre-cast post 400 of FIG. 4 at the right side with the plate elements 221 inside the multi-cell container 300. Like the transitional strap 700 at the left side, the pre-cast post 400 at the right side is heat sealed or glued in the mating area 440 to the end wall 310 of the container 300.

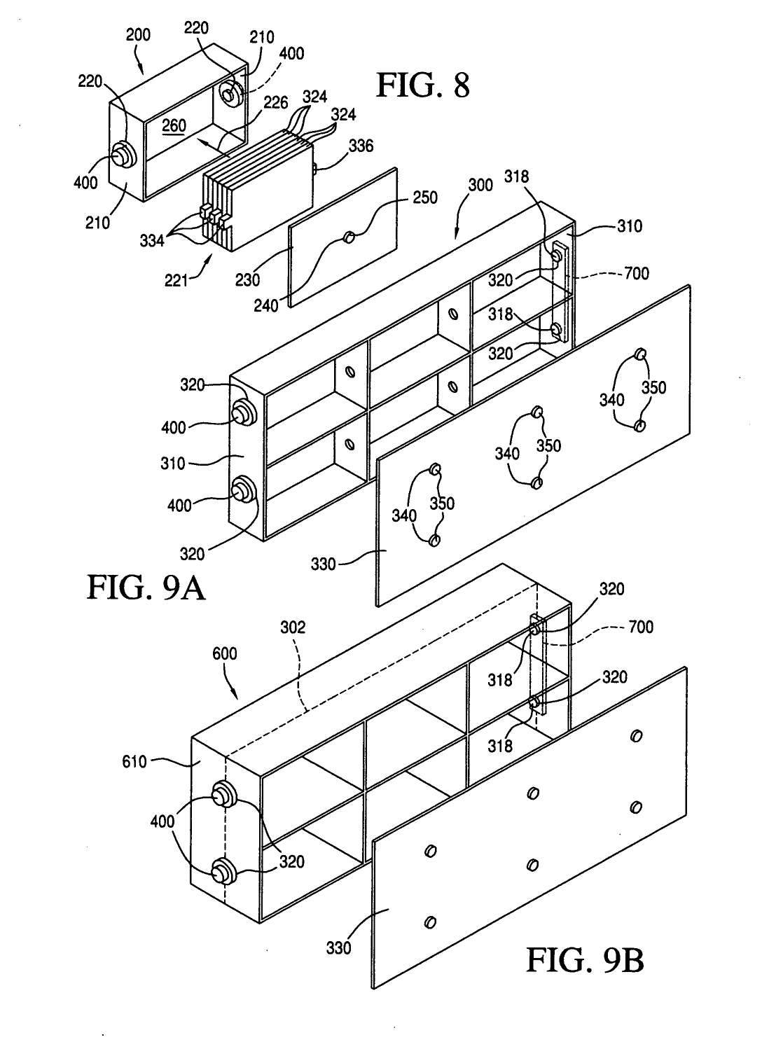

FIG. 8 is similar to FIG. 2 in that FIG. 8 shows the single-cell container 200 with the end walls 210 having the holes 220 filled by the pre-cast posts 400 of FIG. 4. One post 400 is positive and the other is negative. Plural plate elements 221 have multiple positive plates 324, each with the tab 334 on the left side and multiple negative plates 324, each with the tab 336 on the right side. The plural plate elements 221 are inserted in the direction of the arrow 226 into the container 200 until they rest against the back wall 260. The separate cover 230 compresses the plural plate elements 221 when the cover 230 is sealed over the open side of the container 200. The separate cover 230 has the filler vent hole 240 used to fill the container 200 with acid. After the filling is completed, a vent plug 250 is installed.

FIG. 9A is similar to FIG. 3 in that FIG. 9A shows the multi-cell container 300 with the left end wall 310 having the holes 320 filled by the pre-cast posts 400 of FIG. 4. Again, one post is positive and the other is negative. At the right end wall 310 in FIG. 9A, the holes 320 are filled by the protuberances 318 of the transitional strap 700 shown in phantom lines. The separate cover 330 has its vent plugs 350 installed in the holes 340.

FIG. 9B shows a multi-cell container 600 wider than the container 300 of FIG. 9A. If the wider container 600 is employed, then the pre-cast posts 400, the transitional strap 700 and the holes 320 are shifted so that they are aligned along a dashed center line 302. The separate cover 330 provides compression to this wider battery when installed into the open side of the container 600.

Addition of the posts 400, the strap 700 and the holes 320, after the container 600 is molded, simplifies a mold for making the container and allows easy modification to one mold so that it can make containers of various widths. Thus, container tooling costs for a multiple product line is reduced. Moreover, the same pre-cast post 400 of FIG. 4 and the same transitional strap 700 of FIGS. 7A-7C can be used on containers of various widths, thus further reducing the costs for parts and manufacturing.

FIG. 10A is a top plan view of a second embodiment of a single-cell container 800 with a negative plate 825 and a positive plate (not shown) behind the negative plate 825. FIG. 10A also shows top views of an external positive connector 834, an external negative connector 836, clamping bars 842, center bars 844, bolts 852 and pins 854 to be discussed in regard to FIG. 10B.

FIG. 10B is a side view of the container 800 cut away to show interleaved negative plates 825 and positive plates 824 which are secured at both ends by the clamping bars 842 that are tied by the pins 854 through the tabs 834E and 836D to the center bars 844 which in turn are tied to internal posts 846 of T bars 848. The external connector 836 of the left T bar 848 serves as the external negative connection to the external positive connection of an adjacent cell (not shown). The external connector 834 of the right T bar 848 serves as the external positive connection to the external negative connection of another adjacent cell (also not shown). The T bar 848 is one metallic piece and is molded into end walls 810 when the container 800 is formed. By spreading out current flow over the entire width of the tabs 834E and 836D, internal heat caused by resistance in the plates 824 and 825 is reduced and is more efficiently dissipated, thus improving battery life and reducing heat released into the external environment. Benefits of this second embodiment will inure to lithium ion batteries which have very thin plates 824 and 825 that are suitable for clamping together by pins 854 inside the container 800. Note that the external positive connector 834 at the right side is slightly higher in height than the external negative connector 836 on the opposite end 810 so as to allow direct connection between adjacent single-cell containers 800. Thus, no cables are needed to connect such batteries, thereby reducing costs for installing a multi-cell battery.

FIG. 10C shows four single-cell batteries, each in their individual containers 800. At the far right side, a transitional strap or bus bar 870 connects the external positive connector 834 of the top cell with the external negative connector 836 of the bottom cell. Between the left pair of cells and the right pair of cells, the external positive connector 834 of the top left cell overlaps on top of the negative connector 836 (not shown) of the top right cell and are secured together by the bolts 852. Likewise, the external positive connector 834 of the bottom right cell overlaps on top of the external negative connector 836 (not shown) of the bottom left cell.

FIG. 10D shows a top plan view of the negative plate 825, seen in the side view of FIG. 10B, with its negative tab 836D at its left side.

FIG. 10E shows a top plan view of the positive plate 824, seen in the side view of FIG. 10B, with its positive tab 834E at its right side.

FIG. 10F shows a side view of two cells, of the type shown in FIG. 10B, in a single elongated housing 900 having a common wall 910 into which a T bar 948 is molded. Otherwise, each cell is the same as the single cell seen in FIG. 10B. Note that an external positive connector 934 on the right side is slightly higher in height than an external negative connector 936 on the left side so that a plurality of double-cell containers 900 may be coupled directly together.

FIG. 11A is a closed, side perspective view of either the single-cell container 800 of FIG. 10A or the multi-cell container 900 of FIG. 10F. The external positive connectors 834 or 934 protrude from the right side while the external negative connectors 836 or 936 protrude from the left side. The separate cover 330 seals the plate elements (not shown) inside the container 800 or 900.

FIG. 11B shows the prior art container 20 of a lithium ion battery with the plates 24 installed therein. Because the positive post 38 and the negative post 40 are on the same side, the entire width of the plates 24 cannot be connected to their posts, thus creating a higher resistance path for electrical current.

The second embodiment of this invention uses the entire width of each plate as an exit path for the current, thus reducing internal resistance and improving operating efficiency. These advantages result in a reduction of the size and cost of the battery.

In addition, the prior art container 20 of FIG. 11B requires cables to be used to connect adjacent cells. This type of connection adds expense and additional electrical inefficiency to the installed system and does not have the advantages obtained by the direct connection of the external connectors (834, 836 and 934, 936) of the second embodiment of the present invention, as shown in FIGS. 10A-11A.

FIG. 12 is an open side view of the multi-cell container 300 of FIGS. 3 and 9A in which each cell in FIG. 12 contains a plurality of plate elements 221. However, in FIG. 12, only one plate is seen in each cell because the remaining plates are hidden from view behind the top plate. Nevertheless, each plate element 221 has the positive plate (not shown) with its tab 334 and the negative plate (also not shown) with its tab 336 on its opposite side. At the left end of the container 300, two pre-cast posts 400 of FIG. 4 protrude from the end walls 310. In FIG. 12, one post 400 is positive and the other post 400 is negative. At the right end of the container 300, the transitional strap 700 of FIG. 7A connects two adjacent cells together.

FIG. 13A shows the container 300 closed by the separate cover 330 of FIGS. 3 and 9A. In FIG. 13A, the vent plugs 350 are installed in the filler vent holes 340. The transitional strap 700 is shown at the right end of the container 300.

FIG. 13B shows a perspective view of the left end of FIGS. 12 and 13A. In FIG. 13B, the container 300, with the separate cover 330 sealed over the front side, has at its left end two pre-cast posts 400 of FIG. 4. In FIG. 13B, one post 400 is positive and the other post 400 is negative.

A discussion of some benefits and advantages of the invention follows. Because of the configuration of the single-cell container 200 seen in FIG. 8, an assembler can place the plate elements 221, which are identical to the plate elements 221 seen in FIGS. 6, 7B, 7C and 12, face first into the open side, with no resistance to their insertion. Thus, no damage occurs to the plate elements 221 as is possible in the prior art container 20 of FIG. 1 when the plate elements 21 are first compressed prior to insertion edge first.

The plural plate elements 221 in FIG. 8 are identical to the plural plate elements 221 in FIG. 6 and are accessible to connect the positive tab 334 in the one cell 328 to the negative tab 336 in the adjacent cell 322, as seen at the bottom of FIG. 6, or to the external pre-cast post 400, as seen at the top of FIG. 6, by using an electric spot welder.

The separate cover 230 of FIGS. 2 and 8, as well as the separate cover 330 of FIGS. 3, 9A, 9B and 13A, when installed and sealed over the open sides of the containers 200, 300 and 600, respectively, provide even compression to the plate elements 221 of those batteries that require compression. As an example, a sealed VRLA battery having fiber glass mats inside requires compression to hold the acid-filled mats against the plate elements 221 inside the containers 200, 300 and 600. With higher compression, there is less chance of the mats and the plate elements 221 being out of contact with each other. Compression is applied by the separate covers 230 and 330 only after each plate element 221 is installed in its cell 322 or 328. Thus, there is no chance of damage to the plate elements 221, even if a very high compression is applied by the separate covers 230 or 330.

For a VRLA battery, the head space 323 at both ends of FIGS. 6 and 7B can be filled with glass fibers and partially saturated with electrolyte to act as a reservoir. Over time and after much use, a VRLA battery dries out between the prior art plate elements 21 of FIG. 1. However, the electrolyte reservoir provided in the head space 323 of FIGS. 6 and 7B will replace the dried-out electrolyte, thus improving the life and the reliability of the battery.

In the sealed VRLA battery of the prior art shown in FIG. 1, a negative strap (not shown), which connects all negative plate tabs 34 together for the plural plate elements 21, can corrode. This phenomenon is called negative plate strap corrosion. It occurs when the negative tabs 34 are not sufficiently wetted by the electrolyte.

However, the chance of this type of corrosion occurring is significantly reduced in the present invention because the electrolyte in the absorbent glass mat (not shown) in the reservoir created by the head space 323 of FIGS. 6 and 7B is placed on top of all straps (not shown), including the negative plate strap (also not shown) connecting all negative plate tabs 336. Thus, the negative plate strap (not shown) is sufficiently wetted.

By using the separate cover 230 in FIGS. 2 and 8 and the separate cover 330 in FIGS. 3, 9A, 9B and 13A to close the open side of the containers 200, 300 and 600, respectively, instead of a top cover (not shown) for the prior art container 20 of FIG. 1, it is possible to carry out a less heat-destructive method for assembling the external pre-cast post 400 of FIG. 4 and for connecting the post 400 to the strap 327 in FIG. 6 via the riser 329. Because the inside of the containers 200, 300 and 600 is open during assembly, it is possible to heat seal the pre-cast post 400 of FIG. 4 to the container 300 in FIG. 6, to the container 200 in FIG. 8, and to the container 600 in FIG. 9B. It is also possible, as seen in FIG. 6, to use an electric arc welder to fuse the post 400 to the plate strap 327 via the riser 329. This fusing technique uses a low-heat sealing process rather than a gas-fired torch method commonly used for the prior art battery of FIG. 1.

In the multi-cell container 300 of FIGS. 3, 6, 7B, 7C, 9A, 12 and 13A, and the container 600 of FIG. 9B, the separate cover 330 for the open side, instead of the top cover (not shown) on the prior art container 20 of FIG. 1, allows adjacent plate elements 221 to be positioned edge to edge rather than face to face. This edge-to-edge arrangement makes it possible to connect together multiple plate elements 221 that are assembled with the plates 324 having their positive tabs 334 and their negative tabs 336 pointing in opposite directions. FIG. 8 shows plural plate elements 221 having multiple positive plates 324, each with the tab 334 and multiple negative plates 324, each with the tab 336 on opposite sides inside the single-cell container 200 while FIG. 12 shows plural plate elements 221 having the multiple plates (not shown) with their positive tabs 334 and their negative tabs 336 on opposite sides thereof inside the multi-cell container 300. In the prior art container 20 of FIG. 1, the plate elements 21 are shown having plural plates 24 with their positive tabs 34 and their negative tabs 36 positioned so that the tabs 34 and 36 are not opposing each other.

Having a container open on its side instead of the top has several benefits and advantages. As shown in FIG. 12, the plate elements 221 with the opposing tabs 334 and 336 of the plates (not shown) can be connected internally in the multi-cell containers 300 and 600. Opposing tabs 334 and 336 distribute the current load evenly over the surface area of each plate 324, thus reducing effective grid resistance and promoting better usage of the active material inside the battery. This benefit results in more power output and longer battery life. Another advantage is that the battery develops more power per pound of lead used and has an improved cycle life. Also, the battery of the present invention weighs less than the standard prior art battery of FIG. 1 with the same chemistry and capacity.

The plate elements 221 of the present invention are not inserted into the containers 200, 300 and 600 under compression, as is the case with the plate elements 21 in the container 20 of the prior art battery shown in FIG. 1. Laying the plate elements 221 face first into each cell, as seen in FIG. 12, instead of inserting them edge first between two tight narrow walls 23, as is the case in the prior art battery of FIG. 1, eliminates the possibility of tearing the fiber glass mat and any other non-metallic component inside the battery. Thus, greater compression can be applied on the plate elements 221 inside the present invention when the separate cover 230 or 330 is sealed over the open side of the container 200, 300 or 600, respectively.

In FIG. 2, the back wall 260 of the container 200 and the separate cover 230 are parallel to each other. This configuration ensures that compression will be applied evenly across any fiber glass mats or other nonmetallic materials which are layered between the plural plate elements 221 when the separate cover 230 is sealed over the open side of the container 200. The same result is obtained when the separate covers 330 are sealed over the open sides of the multi-cell containers 300 seen in FIGS. 3, 9A and 13A, as well as when the separate cover 330 is sealed over the open side of the wider multi-cell container 600 of FIG. 9B.

In the case of sealed VRLA batteries, this compression by the separate covers 230 and 330 also results in an even distribution of the acid-filled fiber glass mats against the plate elements 221, thus preventing dry spots caused by uneven compression which can cause poor performance in the prior art battery of FIG. 1. Much higher compression can be applied in the present invention after the plural plate elements 221 are connected inside each cell of the container 200, 300 or 600 without risk of damage to the mats.

The walls 22 of the container 20 of the prior art battery in FIG. 1 are tapered so that the container 20 may be easily extracted from its mold during manufacture. This taper results in uneven compression on the fiber glass mats and also increases the likelihood of dry spots forming on the plural plate elements 21, thus resulting in poor performance.

The connection of the cells 322 and 328 end to end in the multi-cell container 300 of FIGS. 3, 6 and 7B, rather than face to face as is done with the plate elements 21 inside the prior art container 20 of FIG. 1, results in a very thin battery which is only one cell wide. On the other hand, all prior art batteries, like the one seen in FIG. 1, are configured with the cells 32 face to face. Thus, they have a large footprint, i.e. they take up a lot of floor space.

When a VRLA battery is discharged, small crystals of lead sulfate are formed. Such formation is normal and not harmful to the battery. However, if the battery is not properly recharged, the lead sulfate crystals grow in size and cannot be transformed upon recharge. Under a continuous partial state of discharge, they can build up to a permanent large size, thereby reducing the capacity of the battery. In other words, the deeper the discharge of the active material in the plates 24, the larger the lead sulfate crystals become.

The prior art battery of FIG. 1A, with its positive tabs 34 and its negative tabs 36 on top of the plates 24, discharge the active material more deeply near the top of each plate element 21 and less so at the bottom of each plate element 21. This activity results in very large lead sulfate crystals being formed at the top of the plates 24. When the crystals become permanently large, the battery loses capacity.

On the other hand, in the present invention, as best shown in FIG. 8, the placement of the positive tab 334 and the negative tab 336 on opposite sides of alternating plates 324 of each plate element 221 causes a more even utilization of the active material, thereby resulting in a shallow depth of discharge over all portions of each plate 324. Since more active material is effectively used over a larger area of each plate 324, the ultimate result is that smaller lead sulfate crystals are formed. Consequently, the battery of the present invention performs with a greater capacity for a longer time under a partial state of discharge.

Also, in the present invention, there is less electrolyte stratification which, in turn, requires less boost charging, thus improving performance and extending battery life.

The containers 200, 300 and 600 have their plate elements 221 arranged with the faces experiencing air temperature through radiation, thus reducing heat buildup within each cell 322 and 328. This feature adds to improved battery life.

In FIG. 12, the container 300 may have any number of cells, even though only six are shown, three positioned end to end in a top line and the same number of cells in a bottom line. This container 300 allows access to the two tabs 334 and 336 on opposite sides of each pair of the plates 324 (not shown) so that connections may be spot welded between adjacent cells. The standard open top of the prior art battery of FIG. 1 has only the top edge exposed for spot welding. Therefore, the tabs 34 and 36 must be on the top edge of their respective plates 24 so that the tabs 34 and 36 are accessible for spot welding to the tabs 34 and 36 of adjacent plates 24.

The thin configuration of the battery container of the present invention can be used advantageously in a motor vehicle, such as an automobile, because it requires less space under the hood, thus providing more room for other equipment. Instead of the large amount of horizontal space taken up by the prior art battery of FIG. 1, the present invention uses vertical space. The thinness of the containers 200, 300 and 600 opens up the possibility that the battery may be mounted in a location other than the engine compartment under the hood. Other possible locations are in the trunk, inside a door panel or even under a seat. Thus, the configuration of the present invention is less obtrusive than the prior art battery of FIG. 1.

Furthermore, multiple battery containers of the present invention may be stacked one on top of another in order to minimize space for use in trucks, marine vessels, military vehicles, telecommunication systems and any other system which requires an uninterruptible power supply.

A spot welder may easily make all electrical connections, for example, as seen in FIG. 6, including the post 400 to the plate element 221 inside the cell 328 and, as seen in FIG. 7B, including the transitional strap 700 to the plate elements 221 inside the cells 328. Spot welding provides a fast and high quality weld in comparison to the slower weld of more variable quality around the prior art post 500 of FIG. 5. This advantage occurs because a spot welder takes much less time by using concentrated heat to effect a proper connection in FIG. 6 between the post 400 and the plate strap 327 via the riser 329. The burning process used in making the prior art battery of FIG. 1 takes more time and more heat, thus resulting in welds of inconsistent quality and the possibility of distorting the plastic cover 530 of FIG. 5.

In FIGS. 6 and 7B, the electrolyte reservoir in the head space 323 at both ends of the cells 322 and 328 inside the container 300 increase the available electrolyte within the sealed VRLA batteries. This reservoir will be discussed in greater detail towards the end of this specification.

The present invention solves several technical problems and fulfills several needs not satisfied by the known prior art. Thus, the present invention has several objectives.

By arranging the separate cover 230 or 330 on the open side of the container 200, 300 or 600 instead of on the open top of the container 20, as in the prior art battery of FIG. 1, it is possible to connect the plate elements 221 end to end with the positive tabs 334 and the negative tabs 336 of the plates 324 opposing each other internally in the single-cell container 200 of FIG. 8 and also in the multi-cell container 300 of FIGS. 6, 7B and 12.

Another benefit of the present invention is that the plural plate elements 221 can be easily placed in the container 200, 300 or 600 before compression is applied by the separate cover 230 or 330, respectively.

When sealed over the open side of the container 200, 300 or 600, the separate cover 230 or 330, respectively, compresses evenly across the surface of any fiber glass mats layered between the faces of the plate elements 221. In effect, the separate cover 230 or 330 acts as a compression device as it is sealed over the open sides of the container 200, 300 or 600, respectively.

After the plural plate elements 221 are inserted into the containers 200, 300 or 600, the separate cover 230 or 330 is sealed thereover. Nevertheless, the face of each plate element 221 experiences the ambient air temperature radiated through the cover 230 or 330 sealed over the open side of the containers 200, 300 or 600, respectively, thus maximizing the cooling effect. However, the face of each plate element 21 installed in the container 20 of the prior art battery in FIG. 1 does not experience the ambient air temperature. Instead, the internal plate elements 21 are face to face with the plate elements 21 in adjacent cells 32, thus minimizing the cooling effect.

The back wall 260 of the container 200 seen in FIG. 8 is parallel to the separate cover 230, thus aiding in providing even compression across the surface of the plural plate elements 221. The prior art container 20 of FIG. 1, with its tapered side walls 22 in contact with the plate elements 21, exhibits uneven compression on the faces of the plate elements 21.

Prior to installing the separate cover 230 or 330 onto the open side of the container 200, 300 or 600, respectively, both sides of the end wall 210 or 310 of FIGS. 6 and 8, respectively, are accessible to the spot welder for connecting the external pre-cast post 400 and the transitional strap 700 to the internal plate element 221. The spot welder uses minimal heat to effect the seal therebetween, thus reducing the possibility of distorting the plastic collar 430, best seen in FIG. 6, around the post 400 and the plastic casing 720, best seen in FIG. 7B, of the transitional strap 700.

In the prior art battery of FIG. 1, the posts 38 and 40 are initially cast onto the adjacent plate elements 21 and then each plate element 21, with the post 38 or 40 attached thereto, is inserted bottom edge (not shown) first into the container 20. The top cover (not shown) is then placed over the posts 38 and 40 and heat sealed to the container 20. As shown in FIG. 5, the cover 530 has the lead insert 510 molded into the cover 530. A gas-fed torch is used to fuse the post 500 to the lead insert 510 or a lead stick (not shown) is melted around the post 500 and the lead insert 510 to create a seal. In contrast to the present invention, significantly more heat is required to make this seal around the prior art post of FIG. 5. Thus, this extra heat increases the likelihood of separating the plastic cover 530 from the lead insert 510.

The battery of the present invention has a longer life than the prior art battery of FIG. 1 because of several factors: uniform usage of the active material of the plate elements 221 inside the container 200, 300 or 600, thus resulting in less stress on the plate elements 221; less stratification of the electrolyte; less sulfation; better heat dissipation; uniform compression of the plate elements 221; and an improved seal around the post 400 due to the use of the spot welder.

There are several features of the present invention believed to have commercial importance.

The thin configuration of the containers 200, 300 and 600 allows more horizontal space for other components under the hood of an automobile. Thus, this configuration also allows the battery to be mounted in locations other than the engine compartment under the hood. Such other locations include but are not limited to the trunk, the door panel and under the floor.

Because the multi-cellular containers 300 and 600 are thin and the posts 400 are located in the end walls 310 and 610, instead of on the top cover (not shown) of the container 20, as is the case with the prior art battery of FIG. 1, this configuration of the present invention enables stacking one battery container 300 or 600 on top of the other in a small and compact manner. Thus, this configuration minimizes the space required for multiple battery applications, such as for trucks, marine vessels, military vehicles, telecommunication systems and any other system requiring an uninterruptible power supply backup system.

As best shown in FIG. 2A, locating the positive tabs 334 and the negative tabs 336 of the multiple alternating plates 24 of the plate elements 221 180 degrees apart improves performance of the battery of the present invention over the prior art battery of FIG. 1. Also, higher cranking amps per pound of lead results for car batteries. More power is also provided over time for other applications, such as backup units for telecommunication and computer systems. The smaller and lightweight battery of the present invention is also less costly to manufacture. Moreover, it saves purchasers valuable floor space. Furthermore, valuable extra space under the hood of an automobile is provided for car manufacturers. As a result of the usage of the lightweight battery of the present invention, a slight improvement in gas mileage occurs for automobiles.

Another advantage of the present invention believed to have commercial importance is its improved reliability.

For example, in the present invention, opposing tabs 334 and 336 distribute the current load evenly over the surface area of the plates 324 of the plate elements 221, thus reducing effective grid resistance and promoting better use of the active material inside the containers 200, 300 and 600. This arrangement results in more output power and longer battery life.

Improved reliability is also obtained because each cell 322 and 328 has at least two side walls experiencing the ambient air temperature, thus enhancing cooling which extends battery life.

Reliability is also improved because the high compressive force exerted by the separate covers 230 and 330, when sealed to the containers 200, 300 and 600, respectively, yields better performance.

As shown in FIG. 8, the back wall 260 is parallel to the separate cover 230 when the latter is sealed to the open side of the container 200, thus providing for uniform compression which yields better battery performance. This uniform compression also occurs for the containers 300 and 600 shown in FIGS. 9A and 9B, respectively.

Reliability is further improved by the electrolyte reservoir in the head space 323 of the cells 322 and 328 in FIGS. 6 and 7B because more electrolyte is provided to VRLA batteries, thus improving their lives.

Reduced costs are obtained by the present invention over the prior art in several respects.

Such reduced costs are gained by the quick and reliable method of installing the plate elements 221 into the containers 200, 300 and 600 and likewise by the method used to seal the external pre-cast post 400 in FIG. 6 to the internal plate element 221 through the strap 327 and the riser 329.

The ability to add electrolyte quickly to the cells 322 and 328 in FIG. 3 through the filler vent holes 340, which are then closed by the plugs 350 of FIG. 9A, further reduces costs. Electrolyte may also be added quickly to the single cell of the container 200 in FIG. 2 through the filler vent hole 240, which is then closed by the plug 250 of FIG. 8.

Reduced costs are similarly obtained by the faster electrical formation of the battery due to the tabs 334 and 336 located opposite from each other on adjacent plates 24 of each plate element 221.

There are several features which make the present invention patentably distinguishable over the known prior art.

As shown in FIG. 12, the assembly of the plate elements 221, each with the positive tab 334 and the opposing negative tab 336 180 degrees apart, is connected together internally in the multi-cell container 300.

As shown in FIGS. 9A and 12, the multi-cell container 300 is only one cell thick. Even compression is applied simultaneously to each plate element 221 when the separate cover 330 is attached to the open side of the multi-cell container 300. The same even compression is applied to the plural plate elements 221 in FIG. 8 when the separate cover 230 is attached to the open side of the single-cell container 200.

Unlike the tapered walls 22 of the prior art container 20 of FIG. 1, the end walls 210 and 310, as well as all other walls (unnumbered), of the single-cell container 200 of FIG. 2 and the multi-cell container 300 of FIG. 3, respectively, do not have any tapers which contact the plate elements 221.

The plural plate elements 221 are placed face first, as best seen in FIGS. 8 and 12, instead of edge first, as is the case with the plate elements 21 of the prior art container 20 of FIG. 1. This face first placement of the plate elements 221 occurs in both the single-cell container 200 of FIG. 8, the multi-cell container 300 of FIG. 12, and the wide container 600 of FIG. 9B.

As seen in FIG. 6, the spot welder connects the external pre-cast post 400, which has been heat sealed or glued in the mating area 440 to the end wall 310 of the container 300, to the strap 327 to the plate element 221 via the riser 329 prior to installing the separate cover 330 of FIG. 3 over the open side of the container 300.

The end result of the present invention is that more power in terms of watts over time is obtained out of both the single-cell battery of FIGS. 2 and 8, the multi-cell battery of FIGS. 6, 7B, 9A, and 12, and the wide battery of FIG. 9B.

In the prior art container 20 in FIG. 1, the electrolyte is suspended in the absorbing glass mat (AGM). In this technology, a fiber glass mat is placed between adjacent plate elements 21. The mat is filled with acid to a saturation point of 92% to 98%, thus leaving only 2% to 8% open space in the mat. This open space allows oxygen gas, generated by electrolysis of water in the electrolyte solution at the positive plate during recharge, to migrate towards and to recombine with hydrogen ions on the negative plate, thus reforming the water in the electrolyte. The electrolytic solution is held between the plate elements 21 by capillary attraction to the glass mat. Capillary attraction is a known physical phenomenon defined as the “force that results from greater adhesion of a liquid to a solid surface than internal cohesion of the liquid itself and that causes the liquid to be raised against a vertical surface”, according to the American Heritage Dictionary at page 199 (Houghton Mifflin Co. 1970).

As seen in FIGS. 6 and 7B, the battery container 300 has head space 323 that is free and open in front and back of the cells 322 and 328. The head space 323 is filled with an electrolyte-absorbing material such as, but not necessarily limited to, fiber glass filaments. Enough electrolyte is already incorporated into the absorbent glass mats between the plate elements 221, plus any other material in the head space 323, to the saturation point of 92% to 98%.

As the water in the electrolytic solution between the plate elements 221 is lost due to electrolysis or other means, electrolyte from the reservoir in the head space 323 will replace it either by gravity or capillary attraction. Thus, this reservoir of extra electrolyte is available for use by the battery. As a result, there is a retardation of the drying out process which is a major cause of AGM battery failure. Consequently, the battery of the present invention lasts longer than the prior art battery of FIG. 1 under hostile conditions, such as high external air temperatures encountered in desert environments. Therefore, the battery of the present invention is more reliable than the prior art battery of FIG. 1.

Sealed VRLA AGM batteries, by their very nature, inherently have a minimal amount of electrolytic solution inside their prior art container. Since they are sealed shut, no water can be added. The plate elements sit edge down on the bottom of the container, thus leaving virtually no space between the edges of the plate elements and the internal walls of the container. However, the head space above the plate elements is free of any electrolyte. Nevertheless, in this prior art arrangement, if the head space were filled with electrolyte, the entire interior of the battery container would be saturated and the water recombination cycle would cease to function, thus defeating the purpose of sealed VRLA AGM batteries.

Drying out is a very common cause of failure in sealed VRLA AGM batteries. This drying out process can be caused by several careless and abusive actions, such as overcharging the battery, using nontemperature-compensated chargers, exposing the battery to very high ambient temperatures, and mounting the battery in nonair-conditioned cabinets. All of these actions increase the electrolysis of the water in the electrolytic solution. The gases generated, if expelled from the battery before they recombine into water, result in the permanent loss of the water and eventually a drying out which results in a failure of the battery.

However, in the present invention, by filling the head space 323 of the cells 322 and 328 in FIGS. 6 and 7B with an electrolyte-absorbing glass mat, instead of air as in the prior art, there is created the reservoir which replaces the electrolyte between the plate elements 221 as the water is lost.

From the foregoing detailed description of the preferred embodiments, it should be apparent to those persons skilled in the art of manufacturing batteries that other constructions and modifications may be made and will still be considered within the scope of the present invention.

Therefore, it should be understood that I do not intend to be limited to the embodiments specifically described hereinabove, but rather it is my intention to be bound only by the scope of the appended claims.

What I claim as my invention is as follows:

1. A battery comprising:
a container having a top, a bottom, two end walls, a closed side wall and an open side;
plural plate elements, formed by connecting together a plurality of positive plates, each plate having a tab on one vertical side, and a plurality of negative plates, each plate having a tab on an opposite vertical side, said plural plate elements being inserted face first and positioned through the open side into the container; and
a cover, separate from the container, for sealing the open side of the container and compressing the plural plate elements inside the container.

2. The battery according to claim 1, wherein the battery is a sealed, valve-regulated, lead acid (VRLA), absorbed glass mat (AGM) type.

3. The battery according to claim 1, wherein the separate cover sealing the open side of the container is parallel to the closed side wall of the container, thus applying even compression on the plural plate elements inserted and positioned into the container.

4. The battery according to claim 1, wherein the battery is a lithium ion type.

5. The battery according to claim 1, wherein the container has a single cell.

6. The battery according to claim 1, wherein the container is multi-cellular.

7. The battery according to claim 1, wherein the container has head space which serves as an electrolyte reservoir.

8. The battery according to claim 1, wherein the container has holes formed in the two end walls.

9. The battery according to claim 8, further comprising:
a pre-cast post arranged in each of the holes formed in the two end walls.

10. The battery according to claim 6, wherein the multi-cellular container has holes formed in the end walls.

11. The battery according to claim 10, further comprising:
a pre-cast post arranged in each of the holes formed in the end walls on one side of the multi-cellular container.

12. The battery according to claim 11, further comprising:
a transitional strap arranged to connect adjacent holes formed in the end walls on an opposite side of the multi-cellular container.

13. The battery according to claim 1, wherein the separate cover has at least one hole formed therein.

14. The battery according to claim 13, further comprising:
a vent plug installed in the hole formed in the separate cover.

15. The battery according to claim 9, wherein the pre-cast post includes a central copper insert surrounded by a lead terminal which, in turn, is partially surrounded by a plastic collar.

16. The battery according to claim 11, wherein the pre-cast post includes a central copper insert surrounded by a lead terminal which, in turn, is partially surrounded by a plastic collar.

17. The battery according to claim 12, wherein the transitional strap includes a metallic electric conductor in a plastic casing which has plugs that provide access for spot welding.

18. The battery according to claim 4, wherein each tab extends across a full width of a side of its plate.

19. The battery according to claim 9, wherein the pre-cast post is arranged in each of the holes formed in the two end walls by either heat sealing or gluing.

20. The battery according to claim 11, wherein the pre-cast post is arranged in each of the holes formed in the end walls by either heat sealing or gluing.

21. The battery according to claim 12, wherein the transitional strap is arranged to connect the adjacent holes by either heat sealing or gluing.

22. The battery according to claim 11, further comprising:
a riser arranged within the container so that the pre-cast post is spot welded to the riser.

23. The battery according to claim 21, further comprising:
a riser arranged within the container so that the transitional strap is spot welded to the riser.

24. The battery according to claim 1, wherein the container is molded to one of various widths.

25. The battery according to claim 24, wherein a size of the separate cover is independent of the width of the container.

26. The battery according to claim 8, wherein the holes are formed by punching.

27. The battery according to claim 10, wherein the holes are formed by punching.

28. The battery according to claim 13, wherein the one hole is formed by punching.
